(19) United States
(12) Patent Application Publication
(10) Pub. No.: US 2022/0319322 A1
(43) Pub. Date: Oct. 6, 2022

(54) DRIVE ASSIST APPARATUS AND DRIVE ASSIST METHOD

(71) Applicant: Mitsubishi Electric Corporation, Tokyo (JP)

(72) Inventors: Keisuke INOUE, Tokyo (JP); Yasushi KODAKA, Tokyo (JP); Hisanobu MASUDA, Tokyo (JP)

(73) Assignee: Mitsubishi Electric Corporation, Tokyo (JP)

(21) Appl. No.: 17/425,915

(22) PCT Filed: Feb. 14, 2019
(86) PCT No.: PCT/JP2019/005178

§ 371 Date: Jul. 26, 2021

(51) Int. Cl. G08G 1/16; G01C 21/32; B60W 30/095

(52) U.S. Cl. CPC G08G 1/16; G01C 21/32; B60W 30/0956; B60W 2554/402; B60W 2556/45; B60W 2554/4041; B60W 2554/4042; B60W 2552/10; B60W 2556/40

(57) ABSTRACT

A drive assist apparatus according to the present disclosure includes: a dynamic information acquisition unit acquiring, as dynamic information, at least one of subject vehicle dynamic information, the other vehicle dynamic information, and obstacle dynamic information from each of a plurality of vehicles; a map data acquisition unit acquiring map data including a shape of a traffic lane; a dynamic information management unit associating the dynamic information and the map data with each other and managing them; an interference prediction unit predicting whether or not the subject vehicle interferes with the other vehicle traveling in front of the subject vehicle along a traffic lane adjacent to a traffic lane along which the subject vehicle travels when the other vehicle avoids the obstacle based on the dynamic information and the map data; and a drive assist information generation unit generating drive assist information based on the predicted result.

### TECHNICAL FIELD

The present disclosure relates to a drive assist apparatus and a drive assist method predicting an interference between the other vehicle and a subject vehicle when the other vehicle traveling in front of the subject vehicle along an adjacent traffic lane avoids an obstacle.

### BACKGROUND ART

The other vehicle traveling in front of a subject vehicle along an adjacent traffic lane may stray onto a traffic lane along which the subject vehicle travels to avoid an obstacle such as a bicycle in some cases. At this time, there is a possibility of interference between the subject vehicle and the other vehicle, thus it is important to predict the interference.

Conventionally disclosed is a technique of calculating a relative position and a relative speed of an obstacle and an upcoming vehicle in an opposite traffic lane relative to the subject vehicle using an in-vehicle car and sensor, and reducing a speed of the subject vehicle in a case where the upcoming vehicle is predicted to go by the subject vehicle when the upcoming vehicle overtakes the obstacle (for example, refer to Patent Document 1). Disclosed is a technique of determining whether or not vehicles go by each other based on positional information of the vehicles aggregated in a control center, presence or absence of an adjacent traffic lane, and an amount of deviation of the vehicle to the adjacent traffic lane (for example, refer to Patent Document 2).

### PRIOR ART DOCUMENTS

### Patent Documents

Patent Document 1: International Publication No. 2015/198426
Patent Document 2: Japanese Patent Application Laid-Open No. 2016-71566

### SUMMARY

### Problem to be Solved by the Invention

In Patent Document 1, when the vehicle or the obstacle is located in a position where it cannot be detected by the in-vehicle camera and sensor, it is impossible to predict whether or not the upcoming vehicle goes by the subject vehicle when the upcoming vehicle overtakes the obstacle. Patent Document 2 is based on an assumption that all the vehicles communicate with the control center, thus it is impossible to determine whether or not the subject vehicle goes by all the vehicle in a road along which both a vehicle having a communication function and a vehicle which does not have a communication function travel.

As described above, there is conventionally a problem that the interference between the other vehicle and the subject vehicle cannot be sufficiently predicted when the other vehicle traveling in front of the subject vehicle along the adjacent traffic lane avoids the obstacle.

The present disclosure therefore has been made to solve problems as described above, and it is an object of the present disclosure to provide a drive assist apparatus and a drive assist method capable of sufficiently predicting an interference between the other vehicle and a subject vehicle when the other vehicle traveling in front of the subject vehicle along an adjacent traffic lane avoids an obstacle.

### Means to Solve the Problem

In order to solve the above problems, a drive assist apparatus according to the present disclosure includes: a dynamic information acquisition unit acquiring, as at least one piece of dynamic information, at least one of subject vehicle dynamic information including a position and a speed of a subject vehicle which is one of a plurality of vehicles, another vehicle dynamic information including a position and a speed of another vehicle located around the subject vehicle, and obstacle dynamic information including a position and a speed of an obstacle located around the subject vehicle from each of the plurality of vehicles; a map data acquisition unit acquiring map data including a shape of a traffic lane which is an attribute of a road; a dynamic information management unit associating the dynamic information acquired by the dynamic information acquisition unit and the map data acquired by the map data acquisition unit with each other and managing the dynamic information and the map data; an interference prediction unit predicting whether or not the subject vehicle interferes with the another vehicle traveling in front of the subject vehicle along a traffic lane adjacent to a traffic lane along which the subject vehicle travels when the another vehicle avoids the obstacle based on the dynamic information and the map data managed by the dynamic information management unit; and a drive assist information generation unit generating drive assist information based on a result predicted by the interference prediction unit.

### Effects of the Invention

According to the present disclosure, the drive assist apparatus predicts whether or not the subject vehicle interferes with the other vehicle traveling in front of the subject vehicle along a traffic lane adjacent to a traffic lane along which the subject vehicle travels when the other vehicle avoids an obstacle based on the dynamic information and the map data managed by the dynamic information management unit, thus predictable sufficiently is the interference between the other vehicle and the subject vehicle when the other vehicle traveling in front of the subject vehicle along the adjacent traffic lane avoids the obstacle.

These and other objects, features, aspects and advantages of the present disclosure will become more apparent from the following detailed description when taken in conjunction with the accompanying drawings.

### BRIEF DESCRIPTION OF DRAWINGS

FIG. 1 is a block diagram illustrating an example of a configuration of a drive assist apparatus according to an embodiment 1 of the present disclosure.

FIG. 2 is a drawing for explaining an adjacent traffic lane according to the embodiment 1 of the present disclosure.

FIG. 3 is a drawing for explaining the adjacent traffic lane according to the embodiment 1 of the present disclosure.

FIG. 4 is a block diagram illustrating an example of a configuration of the drive assist apparatus and an in-vehicle ECU according to the embodiment 1 of the present disclosure.

FIG. 5 is a drawing illustrating an example of dynamic information transmitted from a subject vehicle according to the embodiment 1 of the present disclosure.

FIG. 6 is a conceptual class diagram illustrating an example of a map database according to the embodiment 1 of the present disclosure.

FIG. 7 is a drawing illustrating an example of dynamic information stored in a dynamic information database according to the embodiment 1 of the present disclosure.

FIG. 8 is a flow chart illustrating an example of an operation of an in-vehicle ECU according to the embodiment 1 of the present disclosure.

FIG. 9 is a flow chart illustrating an example of an operation of the drive assist apparatus according to the embodiment 1 of the present disclosure.

FIG. 10 is a flow chart illustrating an example of an operation of the drive assist apparatus according to the embodiment 1 of the present disclosure.

FIG. 11 is a flow chart illustrating an example of an operation of the in-vehicle ECU according to the embodiment 1 of the present disclosure.

FIG. 12 is a drawing illustrating an example of dynamic information transmitted from a subject vehicle according to an embodiment 2 of the present disclosure.

FIG. 13 is a drawing illustrating an example of dynamic information stored in a dynamic information database according to the embodiment 2 of the present disclosure.

FIG. 14 is a flow chart illustrating an example of an operation of an in-vehicle ECU according to the embodiment 2 of the present disclosure.

FIG. 15 is a flow chart illustrating an example of an operation of a drive assist apparatus according to the embodiment 2 of the present disclosure.

FIG. 16 is a drawing illustrating an example of dynamic information transmitted from a subject vehicle according to an embodiment 3 of the present disclosure.

FIG. 17 is a drawing illustrating an example of dynamic information stored in a dynamic information database according to the embodiment 3 of the present disclosure.

FIG. 18 is a flow chart illustrating an example of an operation of a drive assist apparatus according to the embodiment 3 of the present disclosure.

FIG. 19 is a flow chart illustrating an example of an operation of the drive assist apparatus according to the embodiment 3 of the present disclosure.

FIG. 20 is a flow chart illustrating an example of an operation of the drive assist apparatus according to the embodiment 3 of the present disclosure.

FIG. 21 is a flow chart illustrating an example of an operation of an in-vehicle ECU according to the embodiment 3 of the present disclosure.

FIG. 22 is a block diagram illustrating an example of a hardware configuration of the drive assist apparatus according to the embodiments 1 to 3 of the present disclosure.

FIG. 23 is a block diagram illustrating an example of a hardware configuration of the drive assist apparatus according to the embodiments 1 to 3 of the present disclosure.

### DESCRIPTION OF EMBODIMENT(S)

Embodiments of the present disclosure are described in detail based on the drawings hereinafter.

### Embodiment 1

<1-1. Configuration>

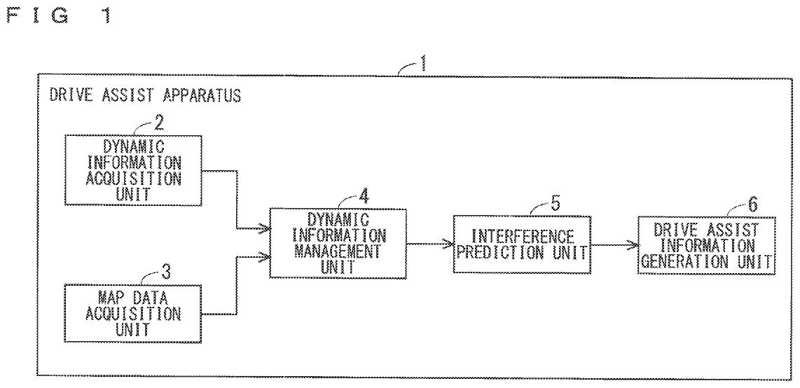

FIG. 1 is a block diagram illustrating an example of a configuration of a drive assist apparatus 1 according to the present embodiment 1. FIG. 1 illustrates a bare minimum of configuration constituting a drive assist apparatus according to the present embodiment 1.

As illustrated in FIG. 1, the drive assist apparatus 1 includes a dynamic information acquisition unit 2, a map data acquisition unit 3, a dynamic information management unit 4, an interference prediction unit 5, and a drive assist information generation unit 6.

The dynamic information acquisition unit 2 acquires, as dynamic information, at least one of subject vehicle dynamic information including a position and a speed of a subject vehicle which is one of a plurality of vehicles, the other vehicle dynamic information including a position and a speed of the other vehicle located around the subject vehicle, and obstacle dynamic information including a position and a speed of an obstacle located around the subject vehicle from each of the plurality of vehicles. Examples of the obstacle include a bicycle, a pedestrian, a falling object, a vehicle under suspension, and a damaged position of a road.

The map data acquisition unit 3 acquires map data including a shape of a traffic lane which is an attribute of a road. The dynamic information management unit 4 associates the dynamic information acquired by the dynamic information acquisition unit 2 and the map data acquired by the map data acquisition unit 3 with each other and manages them. The interference prediction unit 5 predicts whether or not the subject vehicle interferes with the other vehicle traveling in front of the subject vehicle along a traffic lane adjacent to a traffic lane along which the subject vehicle travels when the other vehicle avoids an obstacle based on the dynamic information and the map data managed by the dynamic information management unit 4. The drive assist information generation unit 6 generates drive assist information based on a result predicted by the interference prediction unit 5.

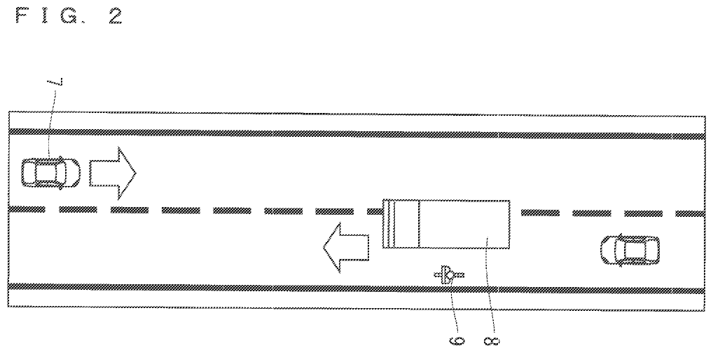

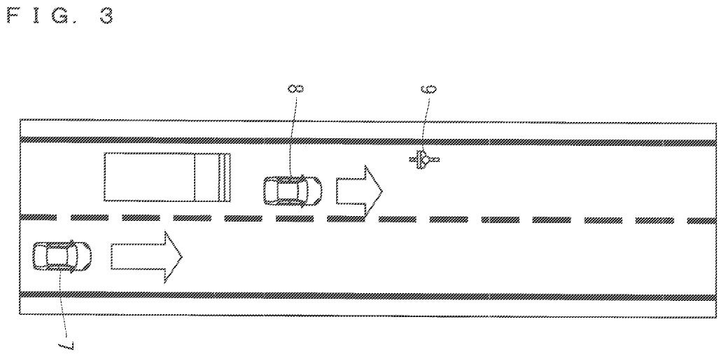

“The adjacent traffic lane” is referred to as a traffic lane located adjacent to a traffic lane along which the subject vehicle travels in the description hereinafter. The adjacent traffic lane includes a traffic lane along which the other vehicle travels in a direction opposite to a traveling direction of the subject vehicle as illustrated in FIG. 2 and a traffic lane along which the other vehicle travels in the same direction as the traveling direction of the subject vehicle as illustrated in FIG. 3. The interference prediction unit 5 predicts whether or not a subject vehicle 7 interferes with the other vehicle 8 when the other vehicle 8 avoids an obstacle 9 in a case where the subject vehicle 7 travels as illustrated in FIGS. 2 and 3.

Described next is the other configuration of the drive assist apparatus including the drive assist apparatus 1 illustrated in FIG. 1.

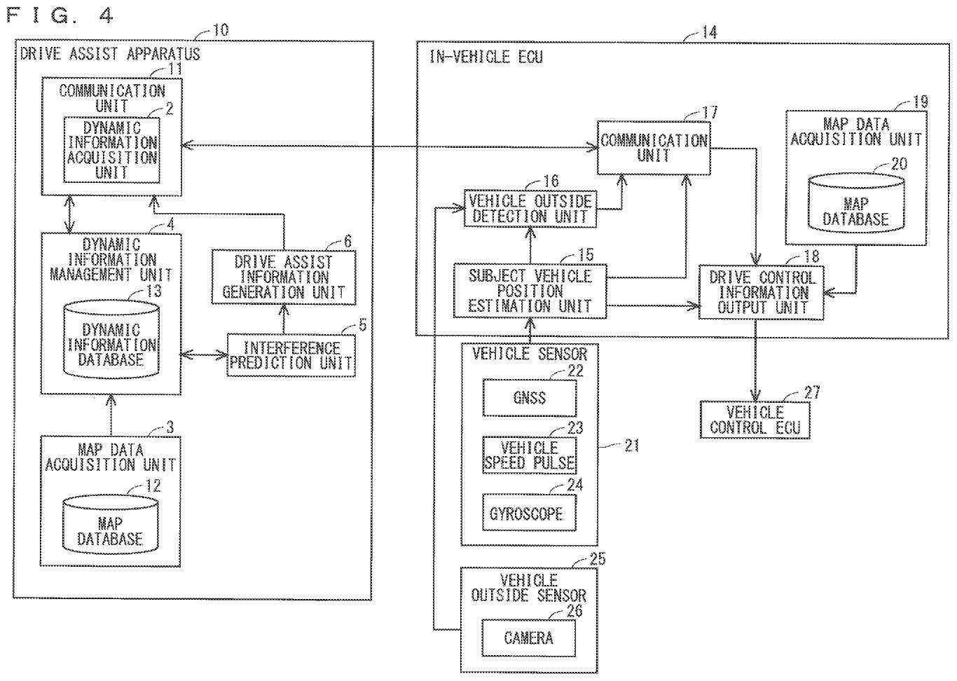

FIG. 4 is a block diagram illustrating an example of a drive assist apparatus 10 according to the other configuration and a configuration of an in-vehicle electronic control unit (ECU) 14 communicably connected to the drive assist apparatus 10. The in-vehicle ECU 14 and the drive assist apparatus 10 are described in this order hereinafter.

<1-1-1. In-Vehicle ECU 14>

The in-vehicle ECU 14 is mounted in the subject vehicle, and includes a subject vehicle position estimation unit 15, a vehicle outside detection unit 16, a communication unit 17, a drive control information output unit 18, and a map data acquisition unit 19. The subject vehicle is provided with a vehicle sensor 21, a vehicle outside sensor 25, and a vehicle control ECU 27 in addition to the in-vehicle ECU 14.

The subject vehicle position estimation unit 15 estimates a current position of the subject vehicle based on information acquired from the vehicle sensor 21. The vehicle sensor 21 is a sensor group including a global navigation satellite system (GNSS) 22, a vehicle speed pulse 23, and a gyroscope 24. The subject vehicle position estimation unit 15 estimates a current position of the subject vehicle based on a position of the subject vehicle acquired by the GNSS 22, a speed of the subject vehicle acquired by the vehicle speed pulse 23, and an angular speed of the subject vehicle acquired by the gyroscope 24. FIG. 4 illustrates a case where the vehicle sensor 21 includes the GNSS 22, the vehicle speed pulse 23, and the gyroscope 24, however, a configuration of the vehicle sensor 21 is not limited thereto. It is sufficient that the vehicle sensor 21 includes a sensor detecting information required for the estimation of the current position of the subject vehicle.

The vehicle outside detection unit 16 identifies at least one of the other vehicle and the obstacle located around the subject vehicle based on information acquired from the vehicle outside sensor 25. The vehicle outside sensor 25 is a sensor group including a camera 26 taking an image around the subject vehicle. The vehicle outside detection unit 16 performs image processing on the image taken by the camera 26, thereby identifying at least one of the other vehicle and the obstacle located around the subject vehicle.

The vehicle outside detection unit 16 performs image processing on the image taken by the camera 26, thereby calculating a relative position and a relative speed of the other vehicle and the obstacle relative to the subject vehicle. FIG. 4 illustrates a case where the vehicle outside sensor 25 includes the camera 26, however, the vehicle outside sensor 25 may include light detection and ranging (LIDAR) and a millimeter-wave radar in addition to the camera 26. In this case, the vehicle outside detection unit 16 can calculate the relative position and the relative speed of the other vehicle and the obstacle relative to the subject vehicle based on information acquired from at least one of the camera 26, the LIDAR, and the millimeter-wave radar.

The communication unit 17 is a gateway, for example, and transmits, to the drive assist apparatus 10, as dynamic information, at least one of the subject vehicle dynamic information including the position and the speed of the subject vehicle, the other vehicle dynamic information including the position and the speed of the other vehicle located around the subject vehicle, and the obstacle dynamic information including the position and the speed of the obstacle located around the subject vehicle. The communication unit 17 receives the drive assist information from the drive assist apparatus 10.

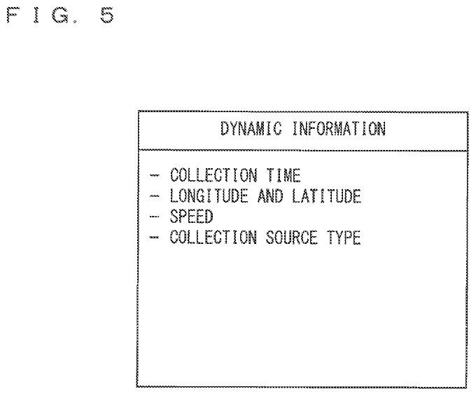

FIG. 5 is a drawing illustrating an example of the dynamic information transmitted from the communication unit 17 to the drive assist apparatus 10. The dynamic information includes at least a collection time, a longitude and latitude, a speed, and a collection source type. The collection time indicates a time at which the subject vehicle position estimation unit 15 acquires the information from the vehicle sensor 21 or a time at which the vehicle outside detection unit 16 acquires the information from the vehicle outside sensor 25. The longitude and latitude indicates a position of the subject vehicle, the other vehicle, or the obstacle. The speed indicates a speed of the subject vehicle, the other vehicle, or the obstacle.

The collection source type indicates which the dynamic information is related to, the subject vehicle, the other vehicle, or the obstacle. For example, when the collection source type is “the self probe”, it indicates that the dynamic information is the subject vehicle dynamic information relating to the subject vehicle including the in-vehicle ECU 14. When the collection source type is “the other vehicle”, it indicates that the dynamic information is the other vehicle dynamic information relating to the other vehicle located around the subject vehicle. When the collection source type is “the obstacle”, it indicates that the dynamic information is the obstacle dynamic information relating to the obstacle located around the subject vehicle. The communication unit 17 transmits each of the subject vehicle dynamic information, the other vehicle dynamic information, and the obstacle dynamic information separately to the drive assist apparatus 10.

Returning to the description of FIG. 4, the drive control information output unit 18 outputs drive control information to the vehicle control ECU 27 based on the drive assist information received by the communication unit 17, the subject vehicle position estimated by the subject vehicle position estimation unit 15, and the map data stored in a map database 20. The vehicle control ECU 27 controls traveling of the subject vehicle based on the drive control information.

The map data acquisition unit 19 acquires map data including a shape of a traffic lane which is an attribute of a road. The map database 20 stores the map data acquired by the map data acquisition unit 19. The map database 20 may be provided outside the in-vehicle ECU 14.

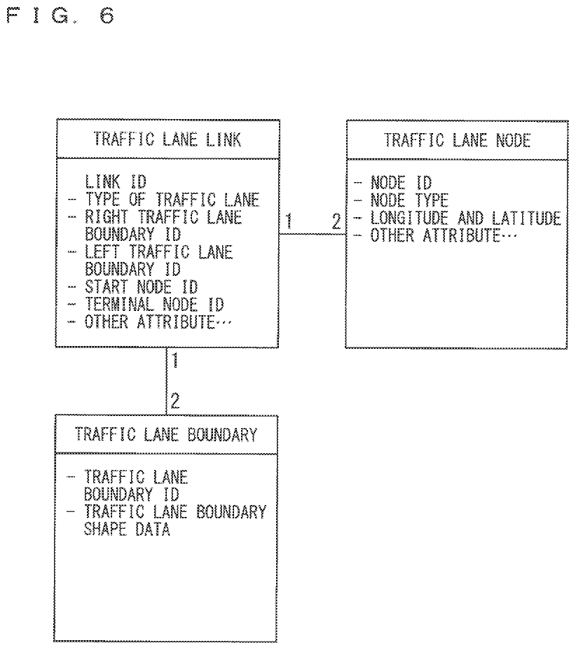

FIG. 6 is a conceptual class diagram illustrating an example of the map database 20. A traffic lane node and a traffic lane boundary are associated with a traffic lane link in the map database 20. The traffic lane link includes a link ID, a traffic lane type, a right traffic lane boundary ID, a left traffic lane boundary ID, a start node ID, and a terminal node ID, for example, as an attribute. The traffic lane node includes a node ID, a node type, and a longitude and latitude, for example, as an attribute. The traffic lane boundary includes a traffic lane boundary ID and traffic lane boundary shape data, for example, as an attribute. An attribute of a road includes an attribute of the traffic lane link, an attribute of the traffic lane node, and an attribute of the traffic lane boundary. The traffic lane boundary shape data which is the attribute of the traffic lane boundary includes a longitude and latitude, and a traffic lane shape can be obtained from the traffic lane boundary shape data.

The in-vehicle ECU 14 may include the dynamic information management unit 4, the interference prediction unit 5, the drive assist information generation unit 6 of the drive assist apparatus 10. That is to say, the in-vehicle ECU 14 may have a function of the drive assist apparatus 10.

<1-1-2. Drive Assist Apparatus 10>

The drive assist apparatus 10 is an information management center disposed outside the vehicle, and includes the map data acquisition unit 3, the dynamic information management unit 4, the interference prediction unit 5, the drive assist information generation unit 6, and a communication unit 11. The map data acquisition unit 3 and the map database 12 are similar to the map data acquisition unit 19 and the map database 20 in the in-vehicle ECU 14, thus the description thereof is omitted herein.

The communication unit 11 is a gateway, for example, and includes the dynamic information acquisition unit 2. The dynamic information acquisition unit 2 acquires, as the dynamic information, at least one of the subject vehicle dynamic information, the other vehicle dynamic information, and the obstacle dynamic information from each of the plurality of vehicles each provided with the in-vehicle ECU 14. The communication unit 11 transmits the drive assist information generated by the drive assist information generation unit 6 to the in-vehicle ECU 14.

The dynamic information management unit 4 associates the dynamic information acquired by the dynamic information acquisition unit 2 and the map data acquired by the map data acquisition unit 3 with each other, and stores them in the dynamic information database 13 to manage them.

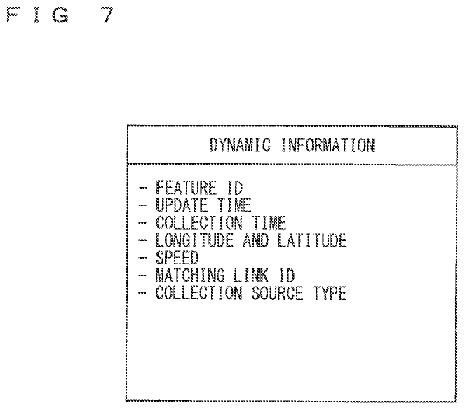

FIG. 7 is a drawing illustrating an example of dynamic information stored in the dynamic information database 13. The dynamic information includes at least a feature ID, an update time, a collection time, a longitude and latitude, a speed, a matching ID and a collection source type. The collection time, the longitude and latitude, the speed, and the collection source type are the same as the collection time, the longitude and latitude, the speed, and the collection source type described in FIG. 5, thus the description thereof is omitted herein. The dynamic information is stored in the dynamic information database 13 for a certain period of time, and is deleted from the dynamic information database 13 if there is no need to use it for the prediction by the interference prediction unit 5 described hereinafter.

The feature ID is an ID for managing all types of dynamic information including the subject vehicle dynamic information, the other vehicle dynamic information, and the obstacle dynamic information. The update time indicates a time at which dynamic information stored in the dynamic information database 13 is updated. The matching link ID indicates a corresponding link ID on a map.

The interference prediction unit 5 predicts whether or not the subject vehicle interferes with the other vehicle traveling in front of the subject vehicle along a traffic lane adjacent to a traffic lane along which the subject vehicle travels when the other vehicle avoids an obstacle based on the dynamic information and the map data managed in the dynamic information database 13 managed by the dynamic information management unit 4. The drive assist information generation unit 6 generates drive assist information based on a result predicted by the interference prediction unit 5.

<1-2. Operation>

Described hereinafter in sequence is an operation of the in-vehicle ECU 14 at a time of transmitting the dynamic information to the drive assist apparatus 10, an operation of the drive assist apparatus 10 relating to the prediction of the interference between the subject vehicle and the other vehicle, and an operation of the in-vehicle ECU 14 at a time of using the drive assist information.

<1-2-1. Operation of In-Vehicle ECU 14 in Transmitting Dynamic Information to Drive Assist Apparatus 10>

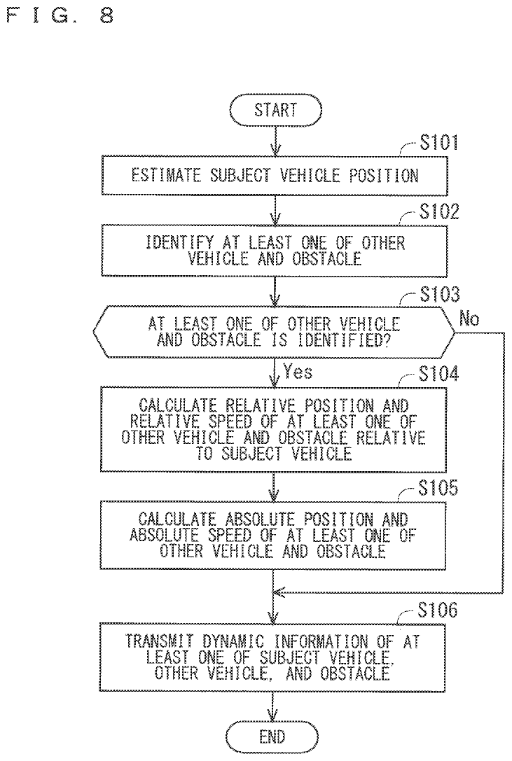

FIG. 8 is a flow chart illustrating an example of an operation of the in-vehicle ECU 14, and illustrates an operation at a time of transmitting the dynamic information to the drive assist apparatus 10. The operation illustrated in FIG. 8 is performed repeatedly at predetermined intervals after an engine of the vehicle is activated until the engine of the vehicle stops afterwards.

In Step S101, the subject vehicle position estimation unit 15 estimates a current position of the subject vehicle based on the information acquired from the vehicle sensor 21. In Step S102, the vehicle outside detection unit 16 identifies at least one of the other vehicle and the obstacle located around the subject vehicle based on the information acquired from the vehicle outside sensor 25.

In Step S103, the vehicle outside detection unit 16 determines whether or not at least one of the other vehicle and the obstacle has been identified. When it is determined at least one of the other vehicle and the obstacle has been identified, the process proceeds to Step S104. In the meanwhile, when neither the other vehicle nor the obstacle is identified, the process proceeds to Step S106.

In Step S104, the vehicle outside detection unit 16 calculates the relative position and the relative speed of at least one of the other vehicle and the obstacle relative to the subject vehicle based on the information acquired from the vehicle outside sensor 25.

In Step S105, the vehicle outside detection unit 16 calculates an absolute position and an absolute speed of at least one of the other vehicle and the obstacle based on the information acquired from the vehicle outside sensor 25 and a current position of the subject vehicle estimated by the subject vehicle position estimation unit 15.

In Step S106, the communication unit 17 transmits the dynamic information of at least one of the subject vehicle, the other vehicle, and the obstacle to the drive assist apparatus 10. That is to say, the communication unit 17 transmits at least one of the subject vehicle dynamic information, the other vehicle dynamic information, and the obstacle dynamic information as the dynamic information. For example, in Step S103, when the vehicle outside detection unit 16 identifies both the other vehicle and the obstacle, the communication unit 17 transmits each of the subject vehicle dynamic information, the other vehicle dynamic information, and the obstacle dynamic information as the dynamic information separately to the drive assist apparatus 10. In Step S103, when the vehicle outside detection unit 16 identifies neither the other vehicle nor the obstacle, the communication unit 17 transmits only the subject vehicle dynamic information as the dynamic information to the drive assist apparatus 10.

<1-2-2. Operation of Drive Assist Apparatus 10 Regarding Prediction of Interference Between Subject Vehicle and Other Vehicle>

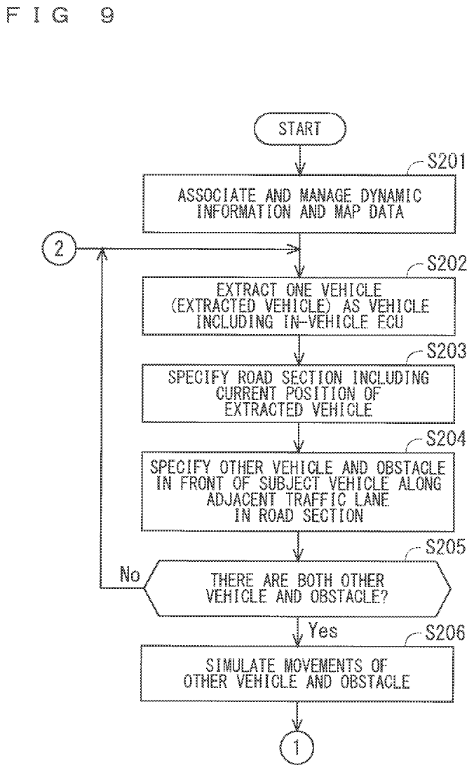

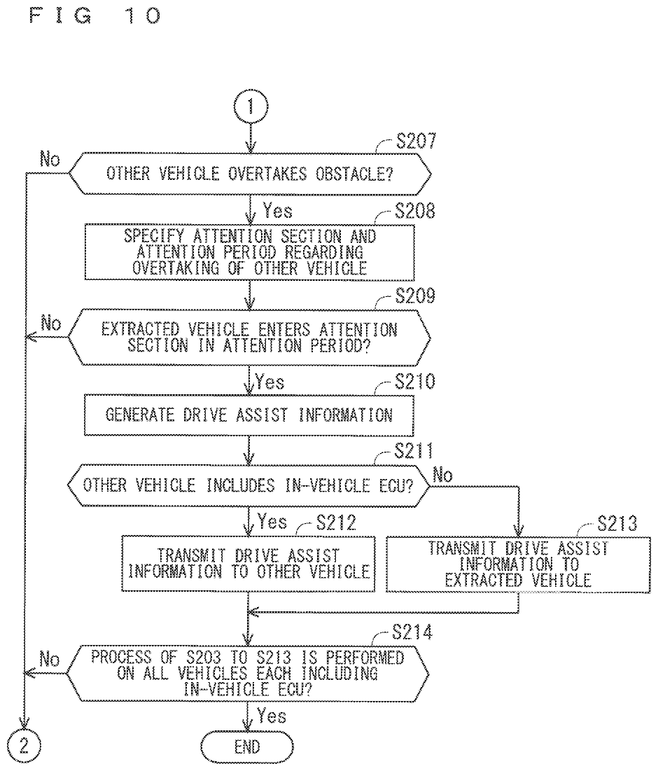

Each of FIGS. 9 and 10 is a flow chart illustrating an example of an operation of the drive assist apparatus 10, and illustrates an operation regarding a prediction of an interference between the subject vehicle and the other vehicle. The operations illustrated in FIGS. 9 and 10 are performed repeatedly at predetermined intervals.

In Step S201, the dynamic information management unit 4 associates the dynamic information acquired by the dynamic information acquisition unit 2 and the map data stored in the map database 12 with each other, and stores them in the dynamic information database 13 to manage them. Specifically, the dynamic information management unit 4 specifies a link ID on a map corresponding to current positions of the subject vehicle, the other vehicle, and the obstacle based on the dynamic information and the traffic lane shape and the attribute of the traffic lane link included in the attribute of the road. The link ID is stored in the dynamic information database 13 as the matching link ID illustrated in FIG. 7.

In Step S202, the interference prediction unit 5 extracts one vehicle as a vehicle including the in-vehicle ECU 14. It can be determined whether or not the vehicle includes the in-vehicle ECU 14 by determining whether or not the collection source type included in the dynamic information stored in the dynamic information database 13 is “the self probe”. In the description hereinafter, the vehicle extracted by the interference prediction unit 5 in Step S202 is referred to as “the extracted vehicle”.

In Step S203, the dynamic information management unit 4 specifies a road section including a current position of the extracted vehicle. Specifically, the dynamic information management unit 4 specifies a plurality of road links including the current position of the extracted vehicle as the road section based on the dynamic information stored in the dynamic information database 13 and the map data stored in the map database 12.

In Step S204, the interference prediction unit 5 specifies the other vehicle and the obstacle located in front of the subject vehicle along the adjacent traffic lane in the road section specified by the dynamic information management unit 4 in Step S203 based on the dynamic information stored in the dynamic information database 13.

In Step S205, the interference prediction unit 5 determines whether or not both the other vehicle and the obstacle are located in front of the subject vehicle along the adjacent traffic lane in the road section specified by the dynamic information management unit 4 in Step S203. When both the other vehicle and the obstacle are located in front of the subject vehicle along the adjacent traffic lane, the process proceeds to Step S206. In the meanwhile, when neither the other vehicle nor the obstacle is located in front of the subject vehicle in the adjacent traffic lane, the process returns to Step S202.

In Step S206, the interference prediction unit 5 simulates movements of the other vehicle and the obstacle located in front of the subject vehicle along the adjacent traffic lane. Specifically, the interference prediction unit 5 simulates the movements of the other vehicle and the obstacle in the road section specified by the dynamic information management unit 4 in Step S203 based on the position and the speed of the other vehicle and the position and the speed of the obstacle.

In Step S207, the interference prediction unit 5 determines whether or not the other vehicle overtakes the obstacle in the road section specified by the dynamic information management unit 4 in Step S203 based on a result of the simulation in Step S206. When the other vehicle overtakes the obstacle, the process proceeds to Step S208. In the meanwhile, when the other vehicle does not overtake the obstacle, the process returns to Step S202.

In Step S208, the interference prediction unit 5 specifies an attention section and an attention period regarding the overtaking of the other vehicle based on the result of the simulation in Step S206. Specifically, the interference prediction unit 5 specifies a section where the other vehicle is predicted to travel when the other vehicle overtakes the obstacle in the road section specified by the dynamic information management unit 4 in Step S203 as the attention section, and specifies a time required for the other vehicle to pass through the attention section as the attention period.

In Step S209, the interference prediction unit 5 determines whether or not the extracted vehicle enters the attention section in the attention period. When the extracted vehicle enters the attention section, the process proceeds to Step S210. In the meanwhile, when the extracted vehicle does not enter the attention section, the process returns to Step S202.

In Step S210, the drive assist information generation unit 6 generates drive assist information including a speed reduction request and the attention section. Specifically, when the interference prediction unit 5 determines that the extracted vehicle enters the attention section in Step S209, the interference prediction unit 5 outputs the speed reduction request and the attention section as the determination result to the drive assist information generation unit 6. The drive assist information generation unit 6 generates the drive assist information including the speed reduction request and the attention section acquired from the interference prediction unit 5.

In Step S211, the dynamic information management unit 4 determines whether or not the other vehicle which has been determined to overtake the obstacle in Step S207 includes the in-vehicle ECU 14. When the other vehicle includes the in-vehicle ECU 14, the process proceeds to Step S212. In the meanwhile, when the other vehicle does not include the in-vehicle ECU 14, the process proceeds to Step S213.

In Step S212, the communication unit 11 transmits the drive assist information to the other vehicle which has been determined to overtake the obstacle in Step S207. At this time, the communication unit 11 may also transmit the drive assist information to the extracted vehicle. In Step S213, the communication unit 11 transmits the drive assist information to the extracted vehicle.

In Step S214, the interference prediction unit 5 determines whether or not the processes of Step S203 to Step S213 have been performed on all the vehicles each including the in-vehicle ECU 14. When the processes have been performed on all the vehicles each including the in-vehicle ECU 14, the operation of FIGS. 9 and 10 is finished. In the meanwhile, when the processes have not been performed on all the vehicles each including the in-vehicle ECU 14, the process proceeds to Step S202.

<1-2-3. Operation of In-Vehicle ECU 14 in Usage of Drive Assist Information>

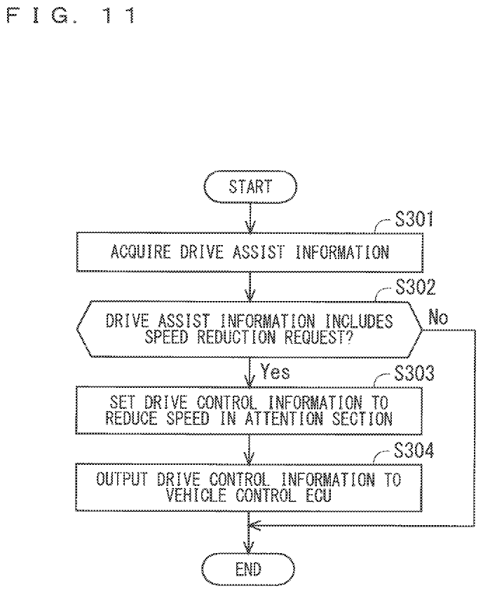

FIG. 11 is a flow chart illustrating an example of an operation of the in-vehicle ECU 14, and illustrates an operation at a time of using the drive assist information. The operation illustrated in FIG. 11 is performed repeatedly at predetermined intervals after an engine of the vehicle is activated until the engine of the vehicle stops afterwards.

In Step S301, the communication unit 17 acquires the drive assist information from the drive assist apparatus 10.

In Step S302, the drive control information output unit 18 determines whether or not the drive assist information acquired by the communication unit 17 includes the speed reduction request. When it includes the speed reduction request, the process proceeds to Step S303. In the meanwhile, when it does not include the speed reduction request, the operation in FIG. 11 is finished.

In Step S303, the drive control information output unit 18 sets the drive control information to reduce the speed in the attention section. In Step S304, the drive control information output unit 18 outputs the drive control information to the vehicle control ECU 27.

The vehicle control ECU 27 performs control so that the subject vehicle reduces the speed in the attention section based on the drive control information acquired from the drive control information output unit 18. The vehicle control ECU 27 may perform the speed reduction so that the subject vehicle reduces the speed to a predetermined speed from a predetermined position before the subject vehicle enters the attention section. At this time, the vehicle control ECU 27 may perform control so that the subject vehicle reduces the speed to a predetermined speed at once, or may also perform control so that the subject vehicle reduces the speed to a predetermined speed in stages. It is also applicable that a driver is notified that the subject vehicle reduces the speed before the vehicle control ECU 27 performs control so that the subject vehicle reduces the speed. The notification to the driver may be performed at any time before the vehicle control ECU 27 performs control so that the subject vehicle reduces the speed.

<1-3. Modification Example>

<1-3-1. Modification Example 1>

Processing of determining whether or not the other vehicle strays onto a traffic lane along which the extracted vehicle travels when the other vehicle overtakes the obstacle may be added between Step S207 and Step S208 in FIG. 9. The interference prediction unit 5 performs the determination.

Specifically, the interference prediction unit 5 may determine whether or not the other vehicle strays onto a traffic lane along which the extracted vehicle travels when the other vehicle overtakes the obstacle in accordance with a type of the traffic lane boundary. In this case, the map data stored in the map database 12 includes the type of the traffic lane boundary which is the attribute of the road (refer to FIG. 6).

Examples of the type of the traffic lane boundary include a wall, a pole, a guardrail, and a boundary line. When the type of the traffic lane boundary is a wall, a pole, or a guardrail which prevents the vehicle from traveling, the interference prediction unit 5 may determine that the other vehicle cannot stray onto a traffic lane along which the extracted vehicle travels when the other vehicle overtakes the obstacle, and return the process to Step S202.

<1-3-2. Modification Example 2>

Processing of determining whether or not the other vehicle strays onto a traffic lane along which the extracted vehicle travels when the other vehicle overtakes the obstacle may be added between Step S207 and Step S208 in FIG. 9. The interference prediction unit 5 performs the determination.

The interference prediction unit 5 may determine whether or not the other vehicle strays onto a traffic lane along which the extracted vehicle travels when the other vehicle overtakes the obstacle in accordance with sizes of the other vehicle and the obstacle. In this case, the other vehicle dynamic information includes information regarding the size of the other vehicle and the obstacle dynamic information includes information regarding the size of the obstacle (refer to FIG. 5).

The map data stored in the map database 12 includes the traffic lane boundary shape data as the attribute, and a distance between the boundaries, that is to say, a width of the traffic lane can be calculated based on the traffic lane boundary shape data. The interference prediction unit 5 can determine whether or not the other vehicle strays onto a traffic lane along which the extracted vehicle travels when the other vehicle overtakes the obstacle in accordance with the width of the traffic lane and the sizes of the other vehicle and the obstacle.

The vehicle outside detection unit 16 of the in-vehicle ECU 14 may perform image processing on the image taken by the camera 26, thereby evaluating the sizes of the other vehicle and the obstacle. At this time, the vehicle outside detection unit 16 may classify the sizes of the other vehicle and the obstacle into a plurality of ranges smaller than 180 cm, 180 cm to 210 cm, and 210 cm to 240 cm, for example.

<1-3-3. Modification Example 3>

Processing of determining whether or not the other vehicle strays onto a traffic lane along which the extracted vehicle travels when the other vehicle overtakes the obstacle may be added between Step S207 and Step S208 in FIG. 9. The interference prediction unit 5 performs the determination.

The interference prediction unit 5 may determine whether or not the other vehicle strays onto a traffic lane along which the extracted vehicle travels when the other vehicle overtakes the obstacle in accordance with types of the other vehicle and the obstacle. In this case, the other vehicle dynamic information includes information regarding the type of the other vehicle and the obstacle dynamic information includes information regarding the type of the obstacle (refer to FIG. 5).

Examples of the type of the vehicle include a small vehicle, a large vehicle, and a bike. Examples of the type of the obstacle include a person and a falling object. The interference prediction unit 5 can determine whether or not the other vehicle strays onto a traffic lane along which the extracted vehicle travels when the other vehicle overtakes the obstacle in accordance with the width of the traffic lane and the types of the other vehicle and the obstacle.

<1-3-4. Modification Example 4>

The longitude and latitude and the speed included in the dynamic information acquired by the drive assist apparatus 10 may be obtained from a sensor included in a mobile communication terminal located together with each of the subject vehicle, the other vehicle, and the obstacle. In this case, the dynamic information is directly transmitted from the mobile communication terminal to the drive assist apparatus 10. The collection source type is “the mobile object” in the dynamic information transmitted from the mobile communication terminal to the drive assist apparatus 10.

<1-3-5. Modification Example 5>

The dynamic information management unit 4 may estimate a position and a speed of the obstacle based on a temporal change of positions of the subject vehicle and the other vehicle. Specifically, the dynamic information management unit 4 estimates that the obstacle is located in a position which the subject vehicle and the other vehicle avoid when the subject vehicle and the other vehicle make movement of avoiding something.

The position and the speed of the obstacle estimated by the dynamic information management unit 4 is stored in the dynamic information database 13. The collection source type is “the estimation” in the dynamic information stored in the dynamic information database 13.

<1-3-6. Modification Example 6>

The dynamic information management unit 4 may combine each dynamic information when a distance between positions included in the plural pieces of dynamic information stored in the dynamic information database 13 is within a predetermined distance. Specifically, the dynamic information management unit 4 refers to the longitudes and latitudes included in the dynamic information, and combines each dynamic information when the longitudes and latitudes are within a predetermined distance and the attribute of each dynamic information is the same as each other.

<1-3-7. Modification Example 7>

Described in Step S210 in FIG. 10 is the case where the drive assist information generation unit 6 generates drive assist information including the speed reduction request and the attention section, however, the configuration is not limited thereto. For example, in Step S209, the interference prediction unit 5 outputs an avoidance request other than the speed reduction request to the drive assist information generation unit 6 when the interference prediction unit 5 determines that the interference between the extracted vehicle and the other vehicle can be avoided by a request other than the speed reduction request. In the in-vehicle ECU 14 acquiring the drive assist information generated by the drive assist information generation unit 6, the drive control information output unit 18 outputs the drive control information including the avoidance request to the vehicle control ECU 27. Considered as the avoidance other than the speed reduction is that the subject vehicle switches lanes to a traffic lane located opposite to a traffic lane along which the other vehicle travels.

<1-4. Effect>

In the present embodiment 1, the in-vehicle ECU 14 transmits, as the dynamic information, not only the subject vehicle dynamic information including the position and the speed of the subject vehicle including the in-vehicle ECU 14 but also the other vehicle dynamic information including the position and the speed of the other vehicle located around the subject vehicle and the obstacle dynamic information including the position and the speed of the obstacle located around the subject vehicle to the drive assist apparatus 10 which is the information management center. Then, the drive assist apparatus 10 predicts whether or not the subject vehicle interferes with the other vehicle traveling in front of the subject vehicle along a traffic lane adjacent to a traffic lane along which the subject vehicle travels when the other vehicle avoids an obstacle using the dynamic information acquired from the in-vehicle ECU 14. Accordingly, it is possible to sufficiently predict the interference between the subject vehicle and the other vehicle traveling in front of the subject vehicle along the adjacent traffic lane in a case where the other vehicle avoids the obstacle in consideration of the vehicle and the obstacle which do not have the communication function.

### Embodiment 2

<2-1. Configuration>

The configuration of the drive assist apparatus and the in-vehicle ECU according to the present embodiment 2 is similar to that illustrated in FIG. 4 described in the embodiment 1, thus the detailed description is omitted herein. In the description hereinafter, the configuration of the drive assist apparatus and the in-vehicle ECU according to the present embodiment 2 is the same as the configuration illustrated in FIG. 4.

<2-1-1. In-Vehicle ECU 14>

The vehicle outside detection unit 16 calculates a relative position and a relative speed of the other vehicle and the obstacle relative to the subject vehicle in the manner similar to the embodiment 1. The vehicle outside detection unit 16 performs image processing on the image taken by the camera 26, thereby acquiring the other vehicle specifying information of specifying the other vehicle located around the subject vehicle. Examples of the other vehicle specifying information include number plate information.

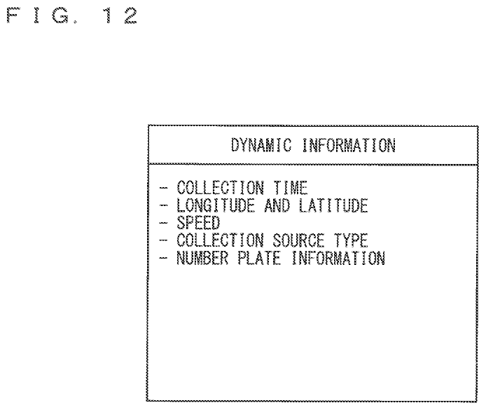

FIG. 12 is a drawing illustrating an example of the dynamic information transmitted from the communication unit 17 to the drive assist apparatus 10. The dynamic information according to the present embodiment 2 has a feature that it includes the number plate information. The number plate information is the other vehicle specifying information when the dynamic information is the other vehicle dynamic information, and is the subject vehicle specifying information of specifying the subject vehicle when the dynamic information is the subject vehicle dynamic information. The other information included in the dynamic information is similar to the dynamic information illustrated in FIG. 5 described in the embodiment 1, thus the description is omitted herein.

<2-1-2. Drive Assist Apparatus 10>

The dynamic information management unit 4 associates the dynamic information acquired by the dynamic information acquisition unit 2 and the map data acquired by the map data acquisition unit 3 with each other, and stores them in the dynamic information database 13 to manage them in the manner similar to the embodiment 1.

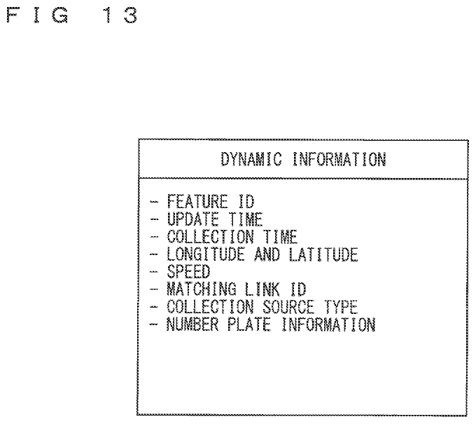

FIG. 13 is a drawing illustrating an example of the dynamic information stored in the dynamic information database 13. The dynamic information according to the present embodiment 2 has a feature that it includes the number plate information. The other information included in the dynamic information stored in the dynamic information database 13 is similar to the dynamic information illustrated in FIG. 7 described in the embodiment 1, thus the description is omitted herein.

<2-2. Operation>

<2-2-1. Operation of In-Vehicle ECU 14 in Transmitting Dynamic Information to Drive Assist Apparatus 10>

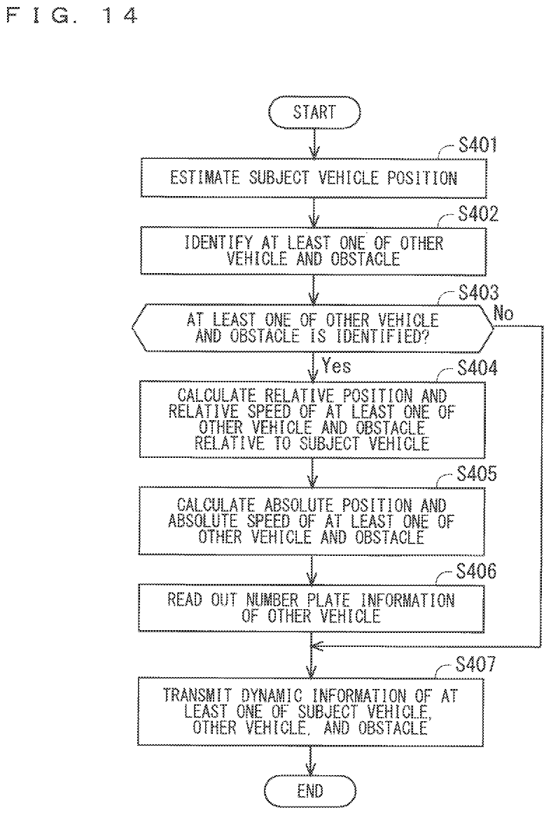

FIG. 14 is a flow chart illustrating an example of an operation of the in-vehicle ECU 14, and illustrates an operation at a time of transmitting the dynamic information to the drive assist apparatus 10. Step S401 to Step S405 in FIG. 14 correspond to Step S101 to Step S105 in FIG. 8, and Step S407 in FIG. 14 corresponds to Step S106 in FIG. 8. Step S406 is described hereinafter.

In Step S406, the vehicle outside detection unit 16 performs image processing on the image taken by the camera 26, thereby reading out the number plate information of the other vehicle located around the subject vehicle.

In Step S407, the communication unit 17 may anonymize the number plate information included in the dynamic information.

<2-2-2. Operation of Dynamic Information Management Unit 4 in Drive Assist Apparatus 10>

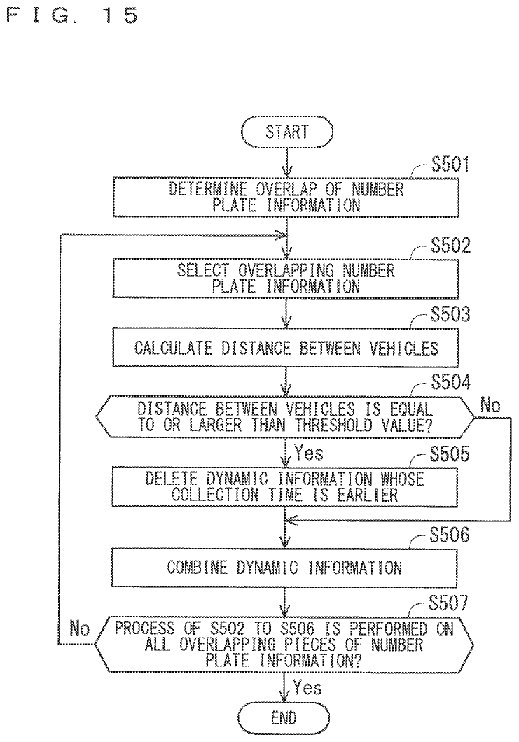

FIG. 15 is a flow chart illustrating an example of an operation of the dynamic information management unit 4 in the drive assist apparatus 10. The operation illustrated in FIG. 15 is performed repeatedly at predetermined intervals or every time the dynamic information acquisition unit 2 acquires the dynamic information.

In Step S501, the dynamic information management unit 4 determines an overlap between the number plate information included in the dynamic information acquired by the dynamic information acquisition unit 2 and the number plate information included in the dynamic information stored in the dynamic information database 13.

In Step S502, the dynamic information management unit 4 selects the plural overlapping pieces of number plate information.

In Step S503, the dynamic information management unit 4 calculates the distance between the vehicles based on the dynamic information including the overlapping pieces of number plate information. Specifically, the dynamic information management unit 4 calculates the distance between the vehicles based on the longitude and latitude included in the dynamic information.

In Step S504, the dynamic information management unit 4 determines whether or not the distance between the vehicles calculated in Step S503 is equal to or larger than a threshold value. When the distance between the vehicles is equal to or larger than the threshold value, the process proceeds to Step S505. In the meanwhile, when the distance between the vehicles is not equal to or larger than the threshold value, the process proceeds to Step S506.

In Step S505, the dynamic information management unit 4 deletes the dynamic information whose collection time is earlier in the plural pieces of dynamic information including the overlapping pieces of number plate information.

In Step S506, the dynamic information management unit 4 combines the plural pieces of dynamic information. Specifically, when there is information included in one piece of dynamic information and not included in the other piece of dynamic information, the dynamic information management unit 4 complements those pieces of information to combine them into one dynamic information. The dynamic information management unit 4 takes an average of the plurality of longitudes and latitudes and the plurality of speeds and combines them. When the collection source type included in the dynamic information is “the self probe”, the dynamic information management unit 4 may give priority to the information included in the dynamic information including “the self probe”.

In Step S507, the dynamic information management unit 4 determines whether or not the process of Step S502 to Step S506 has been performed on the all overlapping pieces of number plate information. When the process has been performed on all overlapping pieces of number plate information, the operation of FIG. 15 is finished. In the meanwhile, the process has not been performed on all overlapping pieces of number plate information, the process returns to Step S502.

<2-3. Effect>

In the present embodiment 2, the in-vehicle ECU 14 incorporates the number plate information into the dynamic information, and transmits the dynamic information to the drive assist apparatus 10. Then, the drive assist apparatus 10 combines the dynamic information including the overlapping pieces of number plate information. Accordingly, accurate positions and speeds of the subject vehicle and the other vehicle around the subject vehicle can be grasped. As a result, the interference prediction unit 5 can perform the more accurate prediction. A storage capacity of the dynamic information database 13 can be ensured.

### Embodiment 3

<3-1. Configuration>

The configuration of the drive assist apparatus and the in-vehicle ECU according to the present embodiment 3 is similar to that illustrated in FIG. 4 described in the embodiment 1, thus the detailed description is omitted herein. In the description hereinafter, the configuration of the drive assist apparatus and the in-vehicle ECU according to the present embodiment 3 is the configuration illustrated in FIG. 4.

<3-1-1. In-Vehicle ECU 14>

The vehicle outside detection unit 16 calculates a relative position and a relative speed of the other vehicle and the obstacle relative to the subject vehicle in the manner similar to the embodiment 2, and acquires the other vehicle specifying information of specifying the other vehicle located around the subject vehicle. In the description of the present embodiment 3, the other vehicle specifying information is the number plate information.

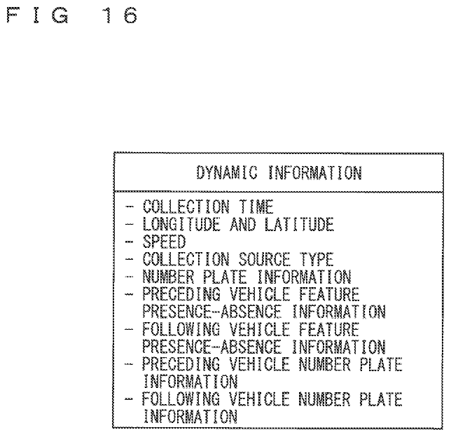

FIG. 16 is a drawing illustrating an example of the dynamic information transmitted from the communication unit 17 to the drive assist apparatus 10. The dynamic information according to the present embodiment 3 has a feature that it includes preceding vehicle feature presence-absence information, following vehicle feature presence-absence information, preceding vehicle number plate information, and following vehicle number plate information.

Each of the preceding vehicle feature presence-absence information and the following vehicle feature presence-absence information is information indicating presence and absence of the other vehicle (a preceding vehicle or a following vehicle) located in front of or behind the subject vehicle. All the other vehicles which can be detected by the vehicle outside sensor 25 fall under the other vehicle located in front of or behind the subject vehicle. The preceding number plate information is number plate information of the preceding vehicle, and the following vehicle number plate information is number plate information of the following vehicle. The other information included in the dynamic information is similar to the dynamic information illustrated in FIG. 12 described in the embodiment 2, thus the description is omitted herein.

<3-1-2. Drive Assist Apparatus 10>

The dynamic information management unit 4 associates the dynamic information including the number plate information acquired by the dynamic information acquisition unit 2 and the map data acquired by the map data acquisition unit 3 with each other, and stores them in the dynamic information database 13 to manage them in the manner similar to the embodiment 2.

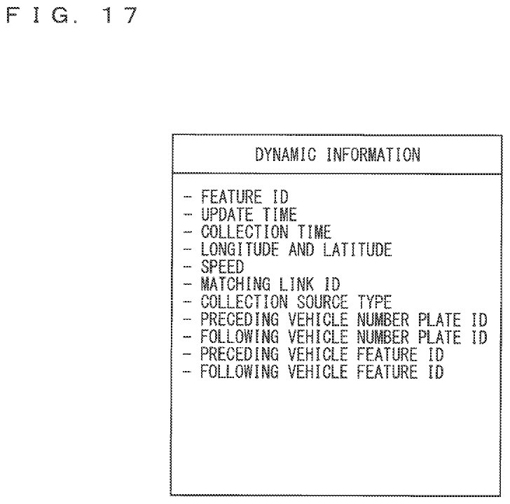

FIG. 17 is a drawing illustrating an example of the dynamic information stored in the dynamic information database 13. The dynamic information according to the present embodiment 3 has a feature that it includes a preceding vehicle feature number plate ID, a following vehicle number plate ID, a preceding vehicle feature ID, and a following vehicle feature ID. The other information included in the dynamic information stored in the dynamic information database 13 is similar to the dynamic information illustrated in FIG. 13 described in the embodiment 2, thus the description is omitted herein.

Each of the preceding vehicle number plate ID and the following vehicle number plate ID indicate a feature ID of the dynamic information regarding the preceding vehicle or the following vehicle in the dynamic information database 13. Each of the preceding vehicle feature ID and the following vehicle feature ID indicates presence or absence of the preceding vehicle or the following vehicle. In this case, a value may be changed between a case where the absence of the preceding vehicle or the following vehicle can be identified and a case where the absence thereof cannot be identified. For example, when the absence of the preceding vehicle or the following vehicle can be identified, the value is set to “0×00” which indicates the absence of the preceding vehicle or the following vehicle. In the meanwhile, when the absence of the preceding vehicle or the following vehicle cannot be identified, the value is set to “NULL” which indicates that the presence or absence of the preceding vehicle or the following vehicle is unknown.

<3-2. Operation>

<3-2-1. Operation of Drive Assist Apparatus 10 Regarding Prediction of Interference Between Subject Vehicle and Other Vehicle>

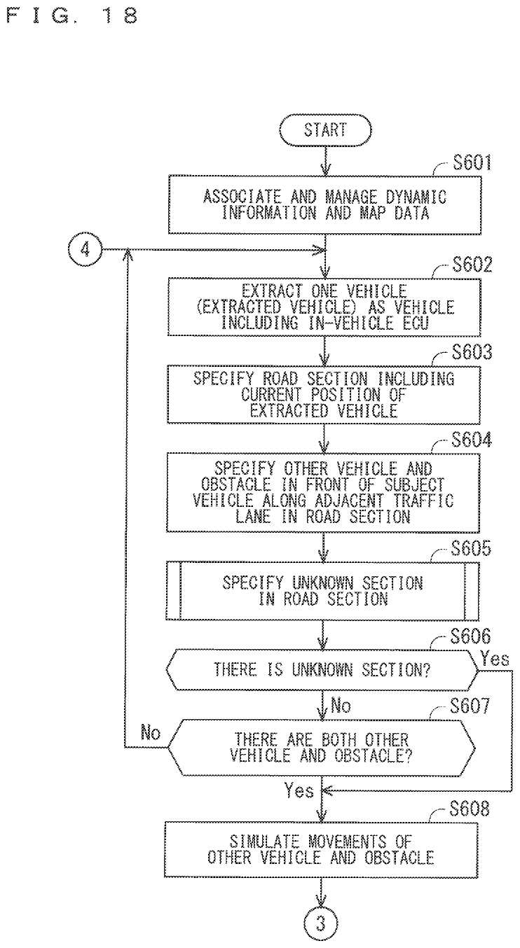

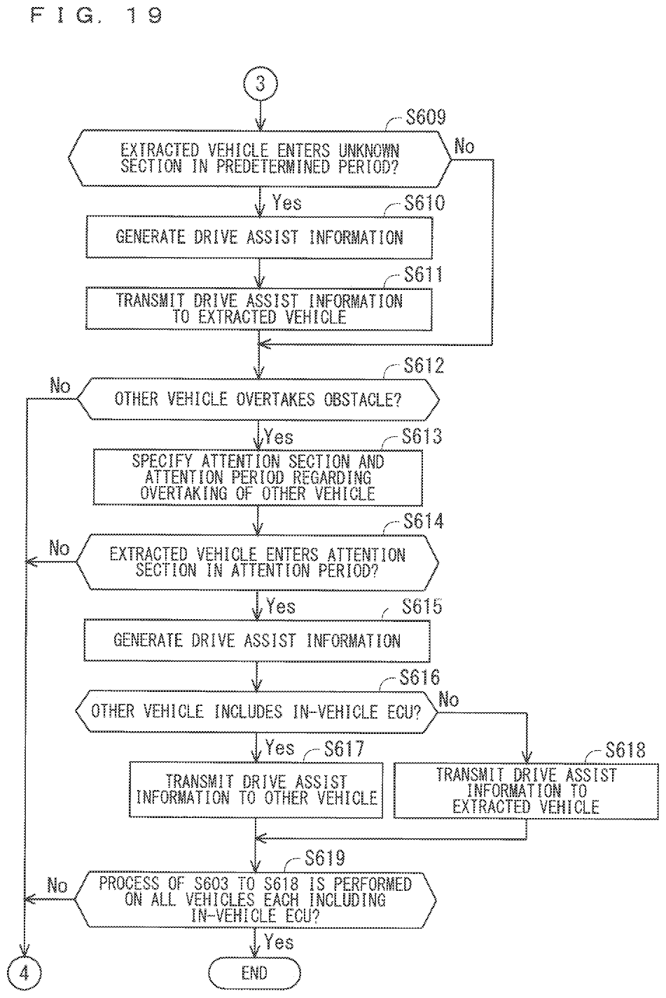

Each of FIGS. 18 and 19 is a flow chart illustrating an example of an operation of the drive assist apparatus 10, and illustrates an operation regarding a prediction of an interference between the subject vehicle and the other vehicle. Step S601 to Step S604 in FIG. 18 correspond to Step S201 to Step S204 in FIG. 9, and Step S612 to Step S619 in FIG. 19 corresponds to Step S207 to Step S214 in FIG. 10. Step S605 to Step S608 in FIG. 18 and Step S609 to Step S611 in FIG. 19 are described hereinafter.

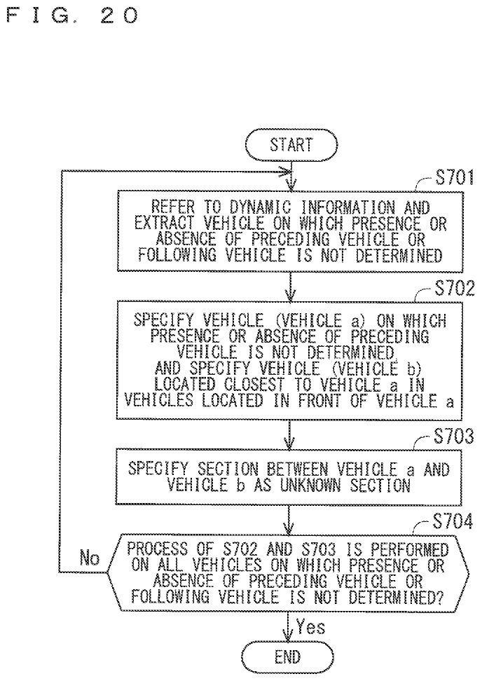

In Step S605, the interference prediction unit 5 specifies an unknown section in the road section specified by the dynamic information management unit 4 in Step S603 based on the dynamic information stored in the dynamic information database 13. Details of the process in Step S605 are described in FIG. 20 hereinafter.

In Step S606, the interference prediction unit 5 determines whether or not the unknown section is included in the road section specified by the dynamic information management unit 4 in Step S603. When the unknown section is included, the process proceeds to Step S608. In the meanwhile, when the unknown section is not included, the process proceeds to Step S607.

In Step S607, the interference prediction unit 5 determines whether or not both the other vehicle and the obstacle are located in front of the subject vehicle along the adjacent traffic lane in the road section specified by the dynamic information management unit 4 in Step S603. When both the other vehicle and the obstacle are located in front of the subject vehicle along the adjacent traffic lane, the process proceeds to Step S608. In the meanwhile, when neither the other vehicle nor the obstacle is located in front of the subject vehicle along the adjacent traffic lane, the process returns to Step S602.

When the interference prediction unit 5 determines that there is no unknown section in Step S606 and both the other vehicle and the obstacle are located in front of the subject vehicle along the adjacent traffic lane in Step S607, the interference prediction unit 5 simulates movements of the other vehicle and the obstacle in front of the subject vehicle along the adjacent traffic lane in Step S608 in the manner similar to the embodiment 1.

When the interference prediction unit 5 determines that the unknown section is included in Step S606, the interference prediction unit 5 simulates changes of the unknown section. Specifically, the interference prediction unit 5 simulates changes of the unknown section using the dynamic information of two vehicles regulating the unknown section.

In Step S609, the interference prediction unit 5 determines whether or not the extracted vehicle enters the unknown section in a predetermined period. When the extracted vehicle enters the unknown section, the process proceeds to Step S610. In the meanwhile, when the extracted vehicle does not enter the unknown section, the process proceeds to Step S611. When it is determined that there is no unknown section in Step S606, the process in Step S609 is omitted and the process proceeds to Step S612.

In Step S610, the drive assist information generation unit 6 generates drive assist information including detail unknown information. Specifically, when the interference prediction unit 5 determines that the extracted vehicle enters the unknown section in Step S609, the interference prediction unit 5 outputs the unknown section as the determination result to the drive assist information generation unit 6. The drive assist information generation unit 6 generates the detail unknown information including the unknown section acquired from the interference prediction unit 5.

In Step S611, the communication unit 11 transmits the drive assist information to the extracted vehicle.

<3-2-2. Operation of Dynamic Information Management Unit 4 in Drive Assist Apparatus 10>

FIG. 20 is a flow chart illustrating an example of an operation of the interference prediction unit 5 in the drive assist apparatus 10, and illustrates a detailed operation in Step S605 in FIG. 18.

In Step S701, the interference prediction unit 5 refers to the dynamic information stored in the dynamic information database 13, and extracts the vehicle on which the presence or absence of the preceding vehicle or the following vehicle is not determined. The interference prediction unit 5 extracts a vehicle on which the presence or absence of the preceding vehicle or the following vehicle is not determined in the road section specified in Step S603.

In Step S702, the interference prediction unit 5 specifies a vehicle on which the presence or absence of the preceding vehicle is not determined (referred to as “the vehicle a” hereinafter), and specifies a vehicle located closest to the vehicle a in the vehicles located in front of the vehicle a (referred to as “the vehicle b” hereinafter).

In Step S703, the interference prediction unit 5 specifies a section between the vehicle a and the vehicle b as the unknown section.

In Step S704, the interference prediction unit 5 determines whether or not the processes of Step S702 and Step S703 have been performed on all the vehicle on which the presence or absence of the preceding vehicle or the following vehicle is not determined. When the processes have been performed on all the vehicles on which the presence or absence of the preceding vehicle or the following vehicle is not determined, the operation of FIG. 20 is finished. In the meanwhile, when the processes have not been performed on all the vehicles on which the presence or absence of the preceding vehicle or the following vehicle is not determined, the process returns to Step S701.

<3-2-3. Operation of In-Vehicle ECU 14 in Usage of Drive Assist Information>

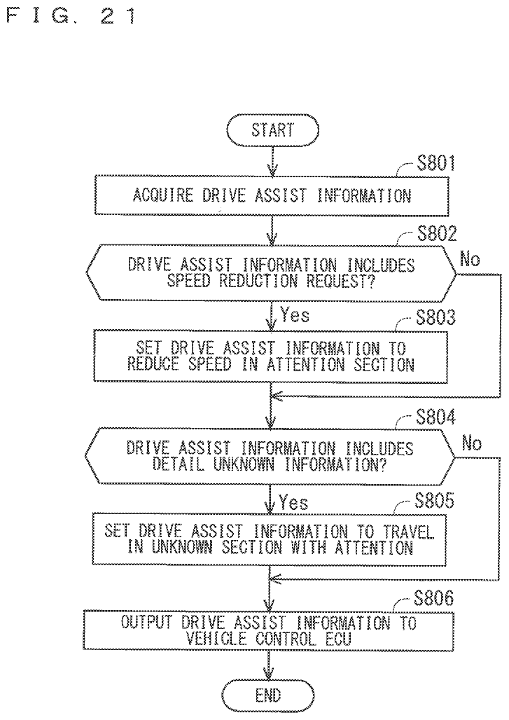

FIG. 21 is a flow chart illustrating an example of an operation of the in-vehicle ECU 14, and illustrates an operation at a time of using the drive assist information. Step S801 to Step S803 in FIG. 21 correspond to Step S301 to Step S303 in FIG. 11, and Step S806 in FIG. 21 corresponds to Step S304 in FIG. 11. Step S804 and Step S805 are described hereinafter.

In Step S804, the drive control information output unit 18 determines whether or not the drive assist information acquired by the communication unit 17 includes the detail unknown information. When it includes the detail unknown information, the process proceeds to Step S805. In the meanwhile, when it does not include the detail unknown information, the process proceeds to Step S806.

In Step S805, the drive control information output unit 18 sets the drive control information so that the subject vehicle travels in the unknown section with attention.

After Step S806, when the drive control information acquired from the drive control information output unit 18 includes a command of reducing the speed in the attention section, the vehicle control ECU 27 performs control so that the subject vehicle reduces the speed in the attention section in the manner similar to the embodiment 1. When the drive control information acquired from the drive control information output unit 18 includes a command of traveling in the unknown section with attention, the vehicle control ECU 27 performs control so that a driver is notified of traveling with attention before the known section, for example. The notification may be performed by sound, a display, or a combination thereof

<3-3. Effect>

In the present embodiment 3, the in-vehicle ECU 14 incorporates the preceding vehicle feature presence-absence information, the following vehicle feature presence-absence information, the preceding vehicle number plate information, and the following vehicle number plate information into the dynamic information, and transmits the dynamic information to the drive assist apparatus 10. Then, the drive assist apparatus 10 specifies the unknown section in the road section to be specified based on the dynamic information. Accordingly, the drive assist apparatus 10 can generate drive assist information in which a section with a clear traffic stream and a section with an unclear traffic stream are classified in the road section. The in-vehicle ECU 14 can notify the driver of traveling in the unknown section with attention based on the drive assist information acquired from the drive assist apparatus 10.

<Hardware Configuration>

Each function of the dynamic information acquisition unit 2, the map data acquisition unit 3, the dynamic information management unit 4, the interference prediction unit 5, the drive assist information generation unit 6, and the communication unit 11 in the drive assist apparatuses 1 and 10 described in the embodiments 1 to 3 is achieved by a processing circuit. That is to say, the drive assist apparatuses 1 and 10 include: a processing circuit for acquiring the dynamic information; acquiring the map data; associating the dynamic information and the map data with each other and managing them; predicting whether or not the subject vehicle interferes with the other vehicle traveling in front of the subject vehicle along the traffic lane adjacent to the traffic lane along which the subject vehicle travels when the other vehicle avoids the obstacle; generating the drive assist information based on the predicted result; and transmitting the drive assist information to the in-vehicle ECU 14. The processing circuit may be dedicated hardware or a processor (also referred to as a central processing unit (CPU), a processing outside, an arithmetic device, a microprocessor, a microcomputer, or a digital signal processor (DSP)) executing a program stored in a memory.

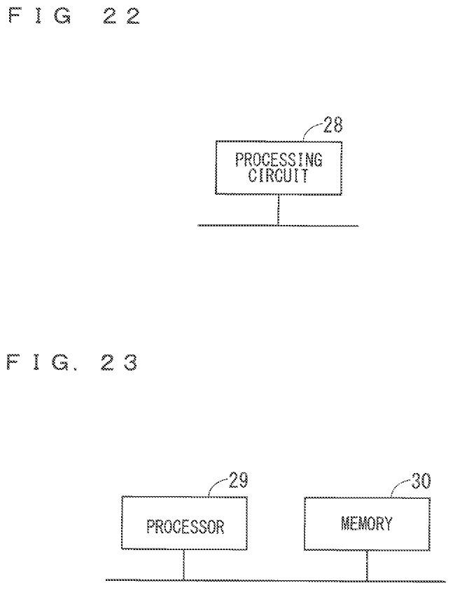

When the processing circuit is the dedicated hardware, a single circuit, a complex circuit, a programmed processor, a parallel-programmed processor, an application specific integrated circuit (ASIC), a field-programmable gate array (FPGA), or a combination of them, for example, falls under a processing circuit 28 as illustrated in FIG. 22. Each of the functions of the dynamic information acquisition unit 2, the map data acquisition unit 3, the dynamic information management unit 4, the interference prediction unit 5, the drive assist information generation unit 6, and the communication unit 11 may be achieved by the processing circuit 28, or each function may also be collectively achieved by the processing circuit 28.

In a case where the processing circuit 28 is a processor 29 illustrated in FIG. 23, each function of the dynamic information acquisition unit 2, the map data acquisition unit 3, the dynamic information management unit 4, the interference prediction unit 5, the drive assist information generation unit 6, and the communication unit 11 is achieved by software, firmware, or a combination of software and firmware. The software or the firmware is described as a program and is stored in a memory 30. The processor 29 reads out and executes a program stored in the memory 30, thereby achieving each function. That is to say, the drive assist apparatuses 1 and 10 include the memory 30 for storing the program to resultingly execute steps of: acquiring the dynamic information; acquiring the map data; associating the dynamic information and the map data with each other and managing them; predicting whether or not the subject vehicle interferes with the other vehicle traveling in front of the subject vehicle along the traffic lane adjacent to the traffic lane along which the subject vehicle travels when the other vehicle avoids the obstacle; generating the drive assist information based on the predicted result; and transmitting the drive assist information to the in-vehicle ECU 14. These programs are also deemed to make a computer execute procedures or methods of the dynamic information acquisition unit 2, the map data acquisition unit 3, the dynamic information management unit 4, the interference prediction unit 5, the drive assist information generation unit 6, and the communication unit 11. Herein, a memory may be a non-volatile or volatile semiconductor memory such as a random access memory (RAM), a read only memory (ROM), a flash memory, an erasable programmable read only memory (EPROM), and an electrically erasable programmable read only memory (EEPROM), or, a magnetic disc, a flexible disc, an optical disc, a compact disc, a digital versatile disc (DVD), or any storage medium which is to be used in the future.

Also applicable is that part of each function of the dynamic information acquisition unit 2, the map data acquisition unit 3, the dynamic information management unit 4, the interference prediction unit 5, the drive assist information generation unit 6, and the communication unit 11 is achieved by dedicated hardware and another part of them is achieved by software or firmware.

As described above, the processing circuit can achieve each function described above by the hardware, the software, the firmware, or the combination of them.

The hardware configuration of the drive assist apparatuses 1 and 10 is described above, and the same applies to the hardware configuration of the in-vehicle ECU 14.

According to the present disclosure, each embodiment can be arbitrarily combined, or each embodiment can be appropriately varied or omitted within the scope of the disclosure.

Although the present disclosure is described in detail, the foregoing description is in all aspects illustrative and does not restrict the disclosure. It is therefore understood that numerous modifications and variations can be devised without departing from the scope of the disclosure.

Explanation of Reference Signs

1 drive assist apparatus, 2 dynamic information acquisition unit, 3 map data acquisition unit, 4 dynamic information management unit, 5 interference prediction unit, 6 drive assist information generation unit, 7 subject vehicle, 8 other vehicle, 9 obstacle, 10 drive assist apparatus, 11 communication unit, 12 map database, 13 dynamic information database, 14 in-vehicle ECU, 15 subject vehicle position estimation unit, 16 vehicle outside detection unit, 17 communication unit, 18 drive control information output unit, 19 map data acquisition unit, 20 map database, 21 vehicle sensor, 22 GNSS, 23 vehicle speed pulse, 24 gyroscope, 25 vehicle outside sensor, 26 camera, 27 vehicle control ECU, 28 processing circuit, 29 processor, 30 memory.

1. A drive assist apparatus, comprising:
a processor to execute a program, and
a memory to store the program which, when executed by the processor, performs processes of,
acquiring, as at least one piece of dynamic information, at least one of subject vehicle dynamic information including a position and a speed of a subject vehicle which is one of a plurality of vehicles, another vehicle dynamic information including a position and a speed of another vehicle located around the subject vehicle, and obstacle dynamic information including a position and a speed of an obstacle located around the subject vehicle from each of the plurality of vehicles;
acquiring map data including a shape of a traffic lane which is an attribute of a road;
associating the dynamic information which has been acquired and the map data which has been acquired with each other and managing the dynamic information and the map data;
predicting whether or not the subject vehicle interferes with the another vehicle traveling in front of the subject vehicle along a traffic lane adjacent to a traffic lane along which the subject vehicle travels when the another vehicle avoids the obstacle based on the dynamic information and the map data which have been managed; and
generating drive assist information based on a result which has been predicted.

2. The drive assist apparatus according to claim 1, wherein
the map data includes a type of a traffic lane boundary which is an attribute of the road, and
the predicting process comprises predicting whether or not the subject vehicle interferes with the another vehicle in accordance with the type of the traffic lane boundary.

3. The drive assist apparatus according to claim 1, wherein
the another vehicle dynamic information includes information regarding a size of the another vehicle,
the obstacle dynamic information includes information regarding a size of the obstacle, and
the predicting process comprises predicting whether or not the subject vehicle interferes with the another vehicle based on the size of the another vehicle and the size of the obstacle.

4. The drive assist apparatus according to claim 1, wherein
the another vehicle dynamic information includes information regarding a type of the another vehicle,
the obstacle dynamic information includes information regarding a type of the obstacle, and
the predicting process comprises predicting whether or not the subject vehicle interferes with the another vehicle based on the information regarding the type of the another vehicle and the information regarding the type of the obstacle.

5. The drive assist apparatus according to claim 1, wherein
the acquiring process comprises acquiring the dynamic information from a mobile communication terminal located together with each of the subject vehicle, the another vehicle, and the obstacle.

6. The drive assist apparatus according to claim 1, wherein
the managing process comprises estimating
a position and a speed of the obstacle based on a temporal change of positions of the subject vehicle and the another vehicle.

7. The drive assist apparatus according to claim 1, wherein
when a distance between positions included in the plural pieces of dynamic information is within a predetermined distance, the managing process comprises combining each of the plural pieces of dynamic information.

8. The drive assist apparatus according to claim 1, wherein
the subject vehicle dynamic information includes subject vehicle specifying information of specifying the subject vehicle,
the another vehicle dynamic information includes another vehicle specifying information of specifying the another vehicle, and
the managing process comprises combining the plural pieces of dynamic information in which the subject vehicle specifying information and the another vehicle specifying information are identical with each other.

9. The drive assist apparatus according to claim 8, wherein
the subject vehicle specifying information and the another vehicle specifying information are anonymized.

10. The drive assist apparatus according to claim 1, wherein
the predicting process comprises specifying a section of a road in which presence or absence of the another vehicle is unknown as a unknown section based on the dynamic information, and
the generating process comprises generating the drive assist information including information of the unknown section.

11. The drive assist apparatus according to claim 1, wherein
when the predicting process comprises predicting that the subject vehicle interferes with the another vehicle,
the generating process comprises generating the drive assist information including information of requesting at least one of the subject vehicle and the another vehicle to reduce a speed.

12. A drive assist method, comprising:
acquiring, as at least one piece of dynamic information, at least one of subject vehicle dynamic information including a position and a speed of a subject vehicle which is one of a plurality of vehicles, another vehicle dynamic information including a position and a speed of another vehicle located around the subject vehicle, and obstacle dynamic information including a position and a speed of an obstacle located around the subject vehicle from each of the plurality of vehicles;
acquiring map data including a shape of a traffic lane which is an attribute of a road;
associating the dynamic information which has been acquired and the map data which has been acquired with each other and managing the dynamic information and the map data;
predicting whether or not the subject vehicle interferes with the another vehicle traveling in front of the subject vehicle along a traffic lane adjacent to a traffic lane along which the subject vehicle travels when the another vehicle avoids the obstacle based on the dynamic information and the map data which have been managed; and
generating drive assist information based on a result which has been predicted.
